(19) United States
(12) Patent Application Publication
(10) Pub. No.: US 2006/0178930 A1
(43) Pub. Date: Aug. 10, 2006

(54) One-way sending time expiring coupon operating method for sale of unsold perishable resources

(76) Inventor: Seong-Su Kim, Seoul (KR)

Correspondence Address: IPLA P.A., 3580 WILSHIRE BLVD., 17TH FLOOR, LOS ANGELES, CA, 90010, US

(21) Appl. No.: 10/560,985

(22) PCT Filed: Jun. 16, 2004
(86) PCT No.: PCT/KR04/01440

§ 371 Date: Dec. 15, 2005

(30) Foreign Application Priority Data
Jun. 17, 2003 (KR) 10-2003-0039215

(51) Int. Cl. G06Q 30/00

(52) U.S. Cl. 705/14; 705/15

(57) ABSTRACT

Disclosed is method to solve the problems in case of food like a fruit or agricultural and industrial goods like a clothing that lose their values as time passes, in case that a movie, a performance, a sport game, a hotel and an airplane ticket of several services to be characterized as the extinctive values to get dismissed and reduced once resources are produced have to be sold out otherwise the seller suffers damage as much and so do the customers because they cannot profitable values of the resources at a low price.

### TECHNICAL FIELD

This invention relates in a kind of a discount sale and especially, the method for employing one-way sending time expiring coupon to promote the sale.

### BACKGROUND ART

There have been several online and offline methods up to now for selling unsold perishable resources that their value becomes extinct rapidly as time passes.

First, the most universal offline method of unsold perishable resources is to sell at a big discount off the price in a sales closing time at sunset in fruit store. This discount sale is, what we call, “a clearance sale.”

“A clearance sale” keeps informed customers of discount sale on air and in voice at the store or through hearsay and an advertisement. However this method has applied restrictedly to sell agricultural and marine products as vegetable, fruit, etc that lose freshness as time goes by and it hasn't applied to sell service goods.

And there has a margin of geographical conditions in being informed the clearance sale of consumers because of the methods and distances to communicate with.

The second generic method offline of unsold perishable resources is of application to clothing sale.

A clothing get lose its values by season-off according to the trait of fashion to sell in clothing discount shop later. Thus each brand has the discount sales network what is called the economy shop. Or the alias giveaway price traders gather them from several brands and stock for sale at a great sacrifice in temporary store. The stocks after all increase the prime cost of clothing and it is brought up in the clothing business because the price of clothing is not valued by a suit of clothes but by weight at a giveaway-price step and it sells at the moderate price. Some companies minimize product stocks through original equipment manufacturing (OEM) by using a point-of-sale (POS) and lead the clothing business field to increase profits. But it couldn't be universalized because the method needs company's holistic reform.

The rest of the offline method of unsold perishable resources, there is a reverse auction way that is realized and serviced by Priceline Inc. in America and it is online method. This reverse auction method covers some service resources like an airplane ticket selling and a hotel room reservation that its schedule and production are fixed. However, those resources is difficult to stock for sale at a sacrifice because the sale closing time is the same as the time that its service is available as like the sale closing time of movie tickets is the time of running movie and customers will wait for the discount time if they would stock for sale at a sacrifice as sells agriculture products and industrial products.

Considering present technical position related to mobile phone-based trade methods through the internet of a portion of this invention, a ticket reservation or e-trade through the wireless internet browser with mobile phone is technologically possible but it has a complex process of purchase for example the consumer has to input credit card number or his/her identification number one by one, and because of the poor interface like small sized screen and of restricted colors from lack of pixels compared to personal computer, it has the insufficient information of goods and of services that leave out of consideration as the important behavior traits that mobile users buy something on the move. From these reasons this e-trade market with mobile phone has not been activated, nevertheless the ringtone downloading and the coloring downloading with mobile phone lead the mobile commerce market because they are easy and need not to worry about the quality of goods although buying without touching and seeing directly and this mobile service market grows by gradually due to a high-pixel and colored cellular phone with game downloading and mobile game on line. However, this service has a margin in activating mobile commercial transaction. And the existing web-based Internet commercial transaction expands their field owing to the utility of the saving of time and effort compared with offline trading, on the other hand, the mobile phone-based Internet commercial transaction does not hold a solid predominance or a difference compared with web-based commercial transaction and it is only applied to sell the restricted resources such a ringtone, a coloring, a game, etc.

The resources that their online sales networks are a movie, a performance, a sports match, an air ticket, a hotel, and a condominium and in case of a full-Line discount store or some supermarket they has a online network for grocery sale in these days. But just some of them serve the real-time shopping and cancel of their orders on line by the sales closing time.

Especially in case of movie and performance online service, Ticketlink gives the service that the customers can make a reservation of tickets of 50 movie theatres as real time before 20 minutes of the running time. But, JUST Communication and MaxMovie allow them to buy and cancel as real time for some theaters before 3 hours 30 minutes of the running time. The online ticket sales networks of movie and performance are concretely classified with two kinds of company. One establishes the ticket issuing system in theater or performance place and also has online booking network system based on it, which is named the theater network company. This is not often connected with the theater network as real time so the booking online used to be able to until only one day before the running day, and some reservation give real-time reservation services with showing the web screen of the network company on their own site. These kinds of theater network companies in Korea are Max movie, InterPark, Cinemad, Just communication, CJ systems, and so on. On the other hand, the companies that give reservation services until only one day before the running day give allocation seat in advanced within limited seats from a theater network company, thus this company uses the method that it calculates sales data after the reservation closed before the running day and sends them by bulk to the network company, so the theater cannot does not deal well with the rest seats usefully.

On a wireless internet technology that is one of base technologies of this patent, the internet by mobile phone's wireless internet browser is based on the WAP protocol and the internet by personal computer is based on HTTP protocol. The WAP protocol can be only used on a mobile phone but HTTP is generally used not related to if its network is a wireless or a wire communication or if it is connected with data modem linked to mobile communication. Thus it is not good to identify wireless Internet with WAP and the two are surely distinguished from according to the using protocol. And wireless LAN evolutes to Portable internet of expanding its area and its using environment and of being connected with seamlessly on the rapid moving. There are mixed using of wireless, wire, and portable Internet. In addition to the Internet connection service using cable modem and ADSL is called super-speed Internet, but it is a matter of common knowledge that a super-speed Internet does not mean the speediest among the data sending technology. Therefore, it is current truth that the use by a dramatic development of Internet technology is flying around before arrange the terminology.

So a coupon sending method based on mobile telephone network or e-mail described in this invention gives the only desirable example, the personalized message sending method that will appear in the future can be utilized in this invention.

An advertising technology using mobile phone is widely used like a message sending skill, a WAP Push which transfer the text message within the sender's phone number to text, a mobile coupon which download into mobile internet as a barcode of expressed graphic, and still used in the only sales method. Among them, there is the service that gazes to the subscriber position and then sends the text message advertising as a real time, but it is difficult to wish for benefit movie and performance in the case of the purchased goods at a low cost. Because the cost per one text message reaches 6 fold in the case of system problem on Communication affairs, it difficult to send the huge massage in comparative to sampling by member information.

The real-time using of GPS (Global Position System) is not an essential factor but an additional method for clearance sale. After this, experts estimate that the cost for text message sending by using real-time position information will be decreased if a subscriber's position system by using GPS is generalized. But, for it, since it needs to upgrade to terminal on the majority of subscriber, it estimates that need more time to be realized.

Among the U.S. patents on the coupon, the patent about a coupon to use certification number is registered in and the applicant is doing the business (The U.S. Pat. No. 5,761,648 Interactive marketing network and process using electronic certificates). But everyone who wants a coupon can has one the coupon has expiration date but the coupon expiration date is insufficient. And it is not new mode of dealing like this invention but is used only as one of the advertising. Also, it has a quiet different form using certification number from gaining benefit.

The mobile phone-based coupon that is an ongoing service gets realized to download the offline coupon service with mobile phone. It is a kind of payment service that makes customers directly connect with coupon site in wireless internet, downloads a graphically realized coupon or an legible image with digital camera, requests an embedded SMS coupon and read and show the clerks it. The Coupack by SK telecom is a kind of those services and is on operating these days. The Coupack distinguishes from off-line coupon in a point reserving function and in a CRM function but it does not surpass a discount rate of the offline, and their dealing goods also equal to offline coupons' goods, so this method is simply used only in sales promotion of products of the primary and secondary industries.

### BRIEF DESCRIPTION OF THE DRAWINGS

FIG. 1 is the whole plan of the one-way sending time expiring coupon system of the case that one-way sending time expiring coupon is used in online sale according to an operating example of this invention.

FIG. 2 is the whole plan of the one-way sending time expiring coupon of the case that one-way sending time expiring coupon is used in off-line sale according to an operating example of this invention.

FIG. 3 is the plan of the one-way sending time expiring coupon server according to an operating example of this invention.

FIG. 4 is the flow chart (a dotted line is organized by member) to show one-way sending time expiring coupon processing according to an operating example of this invention.

FIG. 5 is the flow chart of a process that someone buys a product online and give another person according to an operating example of this invention.

FIG. 6 is the flow chart of a process that recommends their friends to become a member according to an operating example of this invention.

FIG. 7 is a sample table on the dates of commodities database according to an operating example of this invention.

FIG. 8 is a sample table on the sort of commodities database according to an operating example of this invention.

FIG. 9 is a sample table on the sending plans database according to an operating example of this invention.

FIG. 10 is a sample table on the sales rating record database according to an operating example of this invention.

FIG. 11 is a sample table on the sales rating estimation database according to an operating example of this invention.

FIG. 12 is a sample table on the member database according to an operating example of this invention.

FIG. 13 is a sample table on the available terms of purchase database by members according to an operating example of this invention.

FIG. 14 is a sample on the sending rating and sales volume database by members according to an operating example of this invention.

FIG. 15 is a sample table on the database of sending frequency by members according to an operating example of this invention.

FIG. 16 is a sample table on the objective area database by the store position according to an operating example of this invention.

FIG. 17 is a sample table on the sending quota and sales volume database by customer group according to an operating example of this invention.

FIG. 18 is a sample table on the sending database according to an operating example of this invention.

FIG. 19 is a sample table on the sales database according to an operating example of this invention.

FIG. 20 is a sample table on the message database according to an operating example of this invention.

FIG. 21 is a sample table on the sales volume database by the sending plans according to an operating example of this invention.

FIG. 22 is a sample table on the system variables database according to an operating example of this invention.

FIG. 23 is an indicated chart of the sales -volume variation on the sales available capacity according to an operating example of this invention.

[An Explanation of Codes for Major Parts of the FIGs.]

100, 200: one-way sending time expiring coupon server
110: A mobile advertising company server
120: A mobile communication network server
130: A customer's mobile phone
140: A customer's computer
150: A customer
160: A terminal device of a store
170: A sales network server
190: A server of affiliated company of sharing member information
210: Central Processing Unit; CPU
220: RAM
230: ROM
240: CLOCK
250: A communication port
260: Database

### BEST MODE FOR CARRYING OUT THE INVENTION

The Object of this invention is to provide the method to solve the problems in case of food like a fruit or agricultural and industrial goods like a clothing that lose their values as time passes, in case that a movie, a performance, a sport game, a hotel and an airplane ticket of several services to be characterized as the extinctive values to get dismissed and reduced once resources are produced have to be sold out otherwise the seller suffers damage as much and so do the customers because they cannot profitable values of the resources at a low price.

Another object of this invention is to provide the way of realizing the clearance sale that not to be able to under the existing service.

Another object of this invention is to provide a system of buying using the above one-way sending time expiring coupon at online shop and at offline store under wire and wireless internet and using a one-way sending time expiring coupon with message sending technology and with database technology of mobile communication network.

Another object of this invention is to provide a way to raise sale volume comparison to sending volume.

Another object of this invention is to provide an intellectual self-learning marketing solution that gather sale situation of unsold perishable resources from sale network of relevant products in real time and automatically choose target of coupon and send, so have this been continued to sell and get a feedback of sale result and finally reflect again in target selection then this reflected result is accumulated to be a knowledge.

For achieving the above objects, sale method of perishable resources using a one-way sending time expiring coupon is peculiar to a sale schedule update step of information of product lists in communication with sales computer network server according to the update period, a database build-up step of making up and saving a condition, an information, a plan for sending coupon, a step of making up selling rate estimate database that gathers selling rate information in the past, saves in selling rate record database and creates and saves the above saved information, a step of restricting to sending volume by a statement of profit and loss and of making decision for sending coupon volume comparing with a differences from between sale period, sending time and sale closing time, a step of making up sending target extract database by extracting and saving member data correspond to the above sending conditions, a step of giving their own code to the above extracted member data and saving message code chosen the above sending plan database together and of making up sending database and making a coupon, a step of sending the above made-up coupon to the above extracted member, a step that a member who took the above coupon accesses to sale system and confirms membership and a step that the above certificated member chooses the resources he/she wants to buy and forwards the buying decision and pays for.

A sending condition in this invention makes differences between a product information update period and database contents according to a sort of a products.

This invention is characteristic of including more steps of database building on buying condition by members that store available time limits and positional information on the above one-way sending time expiring coupon set by a member.

In this invention, the process of restricting the sending volume of coupon is characteristic of making low the sending volume to the fixed lowest volume or stopping the sending if the value that divides sale volume by sending volume goes down below sale volume rate comparison to sending coupon's volume to send at break-even point among products at a store.

In this invention, in case that there is smaller or fewer differences between sending time and sale closing time than sale period, a sale rest (volume) becomes goal of sale volume if the value to double a multiple of sale volume by double sending volume at p time before sale closing time is same or bigger than an expected rests in sale closing time and a multiple of sale volume becomes goal-of sale volume if the value to double a multiple of sale volume by double sending volume at p time before sale closing time is smaller than an expected rests in sale closing time.

In this invention, in case that the difference between sending time and sale closing time is larger than sale period, the rest of sale becomes goal of sale volume if sale volume at p time before sale closing multiples double sending volume is same as or bigger than the rest of sale in the preceding sending, and i sale volume at p time before sale closing by double sending volume becomes goal of sale volume f sale volume at p time before sale closing by double sending volume is smaller than the rest of sale.

A sending volume in this invention is characteristic of calculating that a sending volume is the goal of sales volume divided by sales volume rate compared with sending volume.

In this invention, a step of extracting member data is characteristic of including a step of extracting member from sending frequency database by referring to coupon sending frequency to member for fixed period saved by type of resources, a step of extracting member who are possible to buy sending target resources now by referring to buying condition setting database to members, a step of extracting members who are in possible geographical condition to buy resources in store by type of resources and P time by referring sending target location database by store location and member information database, a step of extracting member of customer group that is assigned sending volume from member information database and a step of extracting sale volume and sending volume about each members for the last year from sale database and sending database in idle hours of day that no sending coupon, adding up sale quantity and saving to sending volume and sale volume database.

In this invention, a sending method is characteristic of being delivered by a personalized massage sending method.

In this invention, a personalized massage sending method is characteristic of sending through one selected out of a delivery way by mobile advertisement company server and a delivery way by email.

A payment of this invention features to be paid by a selected option out of mobile phone fares, credit cards, e-money, point reserving company and cash in store.

This invention is characteristic of inserting its own code in URL and then making them login after check their identification automatically when a coupon receiver access to sales system.

This invention is characteristic of being compared with two codes that all coupons have their own and saving them with sending information of sale closing time or target product when a coupon receiver access to sales system, it has a step of decide automatically as compares the two which product is possible to buy with the coupon.

This invention features to include a step of understanding a personal buying volume, selling rate by customer group and tracing information of a coupon receiver by using its own code inserted in coupon.

This invention features to include a step of showing first a product sold in store close to residence of a coupon receiver in order to close when product list is shown.

This invention features to include a step of selling more only in the (sale) rest volume to make an estimation not of buying with an amounts to plan to sell at a fixed price in reserve.

This invention features to include a step of forwarding coupon that bought by a member to another person.

This invention features to include a step of recommending another person who takes the above coupon as checking they are member or not if they are not member.

This invention features to include a step of storing another person's information to member database by a member accessed to a one-way sending time expiring coupon server.

Time expiring management system embodied through this invention that includes (i) Non-sending routine(1100); (ii) Sending routine(1200) and (iii) Selling routine(1300). The Sending routine is a doing process whenever each product sends by a schedule and the Non-sending routine(1100) is a routine with a different fulfillment period from the Sending routine.

The Non-sending routine(1100) include each (i) a product-information updating process(S1100) put into operation a process that updates regularly sales schedule of every store according to one product schedule to period by product character; (ii) a sending-plan making out process(S1120) being created automatically by manager's inputting various sending condition to product, a quota to customer group and so forth; (iii) a process of setting a buying condition by members(S1130) that members input/ modify information about when, where and for which product member can apply a coupon to; and (iv.) a selling-rate estimation database making process(S1140) that gather and analysis real data for making selling rate estimation database that will be used estimation of selling.

The above Sending routine(1200) includes (i) opening process(S1210) that check sending plan database and make coupon sending process start automatically; (ii) a coupon sending volume deciding process(S1220) that decide coupon sending volume according to conditions like features and preference of resources, sending time division, goal volume of sale, sale rate estimation value in sale closing time and so forth; (iii) a process of making sending-target extract and sending-target extract condition(S1230) that forwards to mobile advertising agency when extract s sending target from the member list by fixed sending volume, allotment, buying condition by members and sending frequency management or the lack of member, making coupon sending target extract; (iv) a process(S1240) of making a its own code and of inserting into each coupon and of saving sending-database(40O) and of making the peculiar code and grant coupon contents in order that allows only person who received coupon to buy until the only fixed time, to feed back for selling rate comparison to sending volume by each resources and selling rate by customer group, and to decide by comparing to two peculiar codes if sale is possible or not when member who received coupon later can access; (v) a process of requesting coupon-sending and sending the condition for target selecting to mobile advertising agency(S1250) when members are lack of; and (vi) a coupon sending process(S1260) that sending to members extracted from their own members' list.

The above Selling routine(1300) which is a system dealing with a process of selling products using protocol like WAP or HTTP, includes (i) a process of accessing to sale system (S1310) that makes proceed to sale process(S1330) after checking the customers if they are available for selling to or the member, or that login or take a member joining; and (ii) a sale process(S1330) that help choose a product and decide purchase quantity.

Terms' Definition

Time expiring coupon server (100): a server computer that operates system of realized this invention.

Mobile advertisement agency's server (110): a server computer of mobile marketing agency that does advertising service with communicating solution like short message service through mobile communication network and extract target by using member information of mobile phone company. For instance, Aircross, Unwired Korea and so forth as an affiliated company of SK telecom are marketing agency.

Mobile communication network server (120): a server computer and it plays a role of switchboard as stored member information of mobile phone company and is connected to base station covering the whole country, wire telephone network, internet network and another mobile phone company's network.

Mobile communication device of customer (130): a wireless internet usable device like a mobile phone of customer receiving the coupon.

Computer of customer (140): a device that possible to use internet of customer received the coupon and all device having a computing function to access to webpage.

Customer (150): a subject of behavior of buying products and receiver of coupon.

Store terminal (160): a device that is connected to sale network like POS terminal or terminal for tickets is located in store. Seller of products is managing.

Sales network server (170): a server that is stored a data of network can check stock and sell online and managing selling, warehousing, delivery and so forth as a sale network server for target products of the invention. In case the resource that is dealing with is movie tickets, it means a network that can find the total of advance sale and present sale and an online network for advance sale of an aviator, a point-of-sale (POS) of a large discount store management system and so forth. Some company manages directly not sellers of products but sale network like movie and another company manage directly by seller like airplane tickets.

Server of cooperation company sharing member information (190): a cooperation company's server retaining the member information using when we have no our own members, for getting a telephone information of target members.

Product schedule: means that if it has different theater or time with movie of the same title, it is a different product schedule. This is a concept of schedule added to products and is a standard unit in this invention.

P time: the difference between sale closing time of product and sending time of that product. In case of movie, it means difference between screen time and sending time of this coupon. In case of airplane ticket, it means the difference between time of departure and sending time of this coupon.

Sales volume compared with sending volume: means rate of the number of products that sell by using the coupon comparison to sending volume of one-way sending time expiring coupon and as a guide post of one-way sending time expiring coupon business, when it goes down below a fixed standard without taking a rapid recipe, a loss will occur.

Advantageous Effect

The invention has effects on do good to both a maker and a customer by helping that makers can sell goods in stock or unsold perishable resources and customers can buy products at a low price.

The invention has effects on making reconsideration of profitability of whole service industry by enabling service that cannot sell to clearance sale that is not able to sell with an existing way.

In addition, once produced goods have thrown away with they did not consume, there is not only big loss in whole economic point of view but waste of resources without effective practical use in environmental point of view. The complete consume pursuit of produced goods the goal in this invention has effects on raising the efficiency of consume as well as the efficiency of production as an eco-friendly method can prevent no more exhaustive production.

Mode for Invention

Hereinafter called “coupon” without any additional explanation means a one-way sending time expiring coupon.

As referring under the attached FIGs, the invention can be explained in more details.

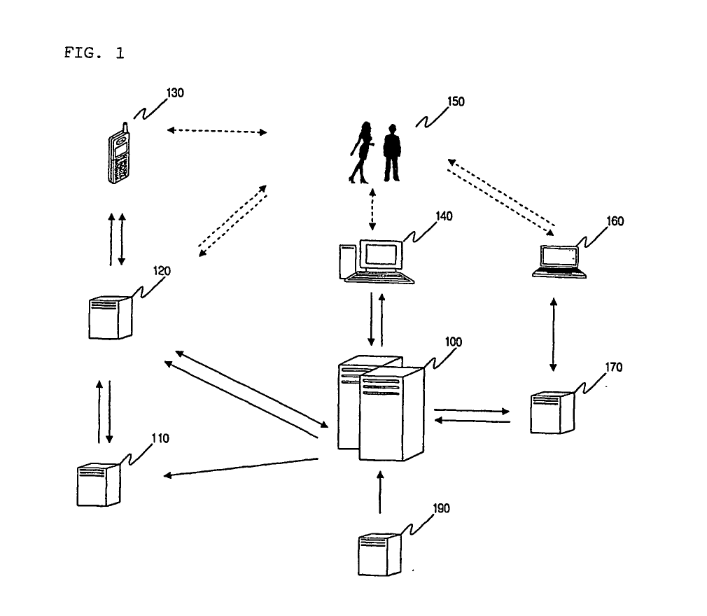

FIG. 1 is the whole plan of the one-way sending time expiring coupon system of the case that one-way sending time expiring coupon is used in online sale according to an operating example of this invention.

In the example, a one-way sending time expiring coupon system includes a one-way sending time expiring coupon server(100), mobile advertising agency's server(110), mobile communication network server(120), mobile communication device of customer(130), computer of customer(140), customer(150), store terminal(160), sales network server(170), and server of cooperation company sharing member information (190).

FIG. 1 shows a flow of making up sending and selling an one-way sending time expiring coupon online.

As referring FIG. 1, a solid line represents devices and relationships online and dotted lines represent the subject and the relationship of offline out of range of this invention.

Sending coupon in the invention is to be classified into three; (i) in case that an enterpriser of a one-way sending time expiring coupon send coupon to their own members, (ii) in case of requesting mobile advertising agency to send to member of mobile communication company, and (iii) in case of sending to members of affiliated companies like credit card company with a lot of members or internet portal company and so forth.

In case of doing a one-way sending time expiring coupon service business with the invention, because its members are few at the beginning of the business and no information about target's name, telephone number of coupon receiver, costing and requesting have to be applied to ask mobile advertising agency to send or send for sharing member information to be affiliated with companies e.g. a credit card company until its own members will be secured, and for reducing of sending cost, these two ways would rather be developed simultaneously because the chance to be sent simultaneously both a sending to its own members and to external panels is high.

As the above statements, online sale is fitted to sell of the service industry's products like tickets of movie, public performance or airplane that customer can buy without checking out directly the condition of products because they have few difference between the each products.

In FIG. 1, sending, sale, approval can be achieved by next various methods.

Coupon sending process as the above statements is to be classified detail into 3 ways (i) route using a mobile advertising agency's server, (ii) route using their own massaging server and Internet, (iii) route using e-mail.

The above sale route is also to be classified into two ways, (i) sale of using internet based on mobile phone, (ii) sale of using a general internet.

The above route of sale charge approval is to be classified into (i) the way of adding to mobile phone's charge together, (ii) the way of credit card, (iii) the way of approval by e-money, (iv) the way of using point reserve company and (v) the way of paying in store.

In case of coupon sending and sale by using the above mobile communication network, first, if checking the products' quantity, service schedule and so forth from sale network server (170) of relevant products, setting the sending quantity, target, message and so forth, making out sending conditions, and forwarding them to mobile advertising agency's server(110) of mobile advertising agency, mobile advertising agency's server(110) can extract target on sending conditions and send coupon by using mobile communication network server(120) customer(150) who received a type of coupon like SMS(SMS: short message service) or multi media message(MMS: multimedia message service) informed discount of movie, public performance and so forth can access through a call back URL(call back URL) and easily access to the one-way sending time expiring server(10O) by pushing access button through mobile communication network and buy wish products through the realized screen by internet based on mobile phone at that time approval is done by the above ways.

At that time, if customers who received coupon want to buy through the personal computer because they feel a burden about wireless Internet access charge or not be good at using wireless internet, customers can type own access code in coupon message on using a keyboard of personal computer (140) and can buy after the target certification.

In regarding of sending process of a one-way sending time expiring coupon using the above e-mail, a one-way sending time expiring coupon server searches the member database and e-mails to affected member using internet. The above email includes the their own number. A member who wants to buy among who receives the above email can access to the affected online address. And the access process and purchase process are the same as the above.

After the above approval, a one-way sending time expiring coupon server (100) sends and stores result of sale e.g. buyer, sale quantity, whether charge is approved or not and so forth on sales network server (170). If the customer who buys a resource comes to the shop and asks one, a clerk input the customer's id no on the shop's terminal and inquires of his/her purchase and its information equals to his/her purchase information, a clerk hands in a resource to the customer when his/her payment is confirmed.

If the above approval is progressed by a credit card, the payment information is sent to credit card Company, and if the above approval is progressed by mobile phone with an add up mobile phone charge, the payment information is sent to mobile phone company. And each company, and each company request their customer to pay. Sale fee is divided by rate to compromise between seller and enterpriser of one-way sending time expiring coupon, and provides a commission for using sale network if there is separate sale network enterpriser.

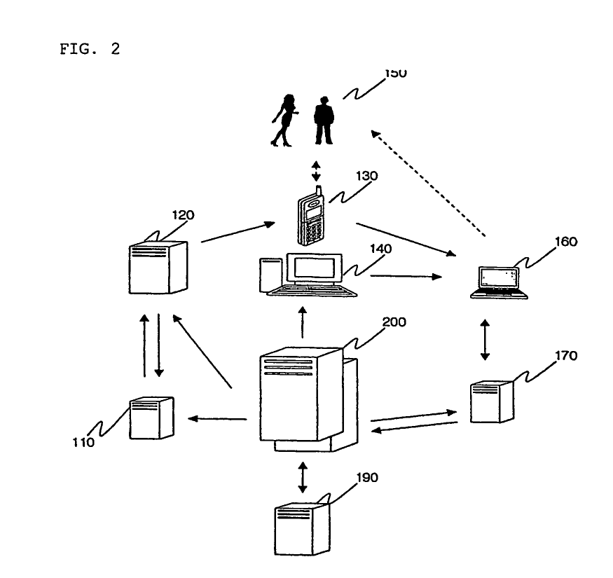

FIG. 2 is a general view of a one-way sending time expiring coupon system in case of using a one-way sending time expiring coupon at offline sale as one example of this invention.

In the example of above statements, one-way sending time expiring coupon system includes one-way sending time expiring coupon server(100), mobile advertisement agency's server(110), mobile communication network server(120), mobile communication device of customer(130), computer of customer(140), customer(150), 'store terminal(160), sales network server(170), and server of cooperation company sharing member information(190).

The example of above statements shows the case of sales using coupon offline.

As referring FIG. 2, products that manage mainly as a general view of the invention could be products of a primary industry and a secondary industry, so the way used mainly sales of products that customers want to buy after checking directly because of having a quiet big difference of quality between each product. When brand recognition level is low, third industrial products also need to offline sale sometimes.

In case of FIG. 2, its coupon sending process also has the same process of FIG. 1, but it is different from in points that selling is done after customers arrive in store. In case of FIG. 1, the sale of using coupons is progressed with networking between the customer's mobile phone or computer and a one-way sending time expiring coupon server, but in case of FIG. 2, a customer shows the own code received on a mobile phone to a clerk or sending it offline to the shop's terminal with a barcode network, IrDA network, and RF network.

The way of using coupon in offline sale by the above constitution is mainly advisable to be used in primary, secondary industrial products and the way of using coupon online is mainly advisable to be used in third industrial products. As two above constitutions are to be classified for convenient explanation, they could be realized in two ways of one system or in one way between two ways case by case when this invention is realized.

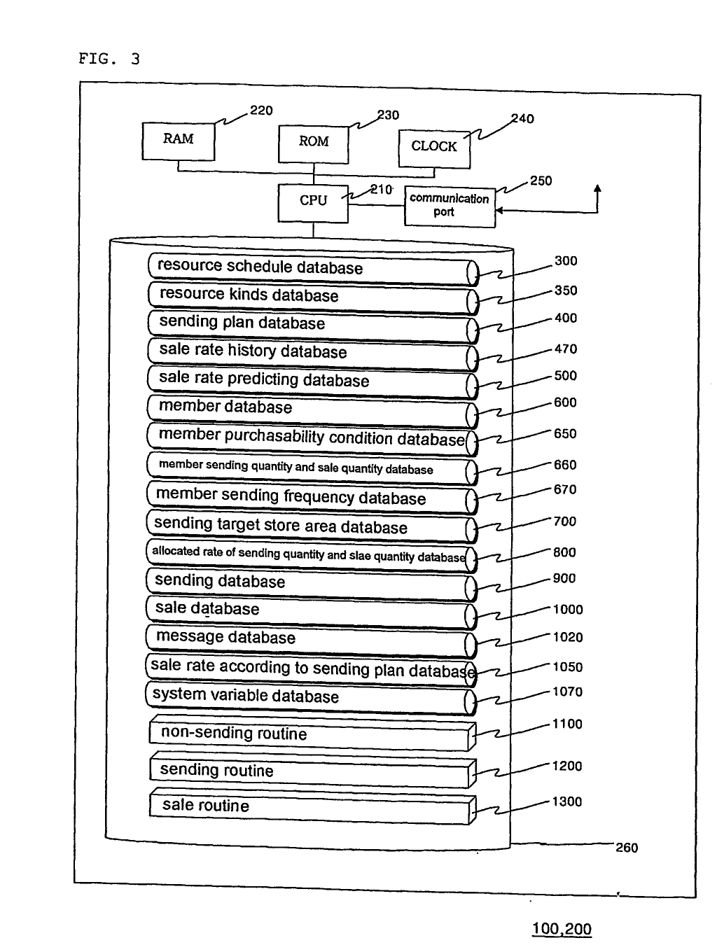

FIG. 3 is a general view of a one-way sending time expiring coupon server (200) as one example.

In the above example, a one-way sending time expiring coupon server includes memory storage (220, 230), central process unit(210), clock(240), i/o port(250), database(260).

The above example shows state of making database in memory storage of one-way sending time expiring coupon server.

As referring FIG. 3, hardware composition of the system is very easy to do if they are enterprisers. Thus we abridge concrete explanation and mention later about database included memory storage.

FIG. 4 is a flow chart that shows a process of dealing with a one-way sending time expiring coupon as one example. (A part of dotted line is done by customer)

In the above example, the steps of dealing with a one-way sending time expiring coupon include a sale schedule update process (Sb110), a sending plan making out process(S1120), a process of setting a buying condition to members(S1130), a selling rate estimation making process(S1140), opening process of sending process(S1210), a decision making process of coupon sending quantity(S1220), a condition making of extract process of sending coupon (S1230), a giving their own code and contents insert process(S1240), a request coupon sending to mobile advertising agency(S1250), a their own sending process(S1260), an access process to sale system(S1310) and a sale process (S1330)

The above example shows a process that sends a one-way sending time expiring coupon about one product.

As referring FIG. 4, a sale schedule update process (S1110) is a step of saving to sale schedule database (300) after inquiring store's name and schedule like product's name of trying to sell, sale opening and closing time and so forth from sale network server set with update period by kinds of a product.

For example, in a movie theatre, it is newly updated with the latest schedule every morning before movie runnings that search all schedules of movie running through ticket network.

Sending plan making out process (S1120) is a process that an administrator of one-way sending time expiring coupon system inputs all these following conditions and revises it and then the system completes the DB 400 (sending plan database) automatically.

Generally in a movie, it is needed to input sending conditions in a bundle before starting a movie. It should be cautious that there are some differences on input cycle and contents on kinds of resources.

The input contents are recommendatory to be consisted of following conditions; a. Method of coupon sending on resources and the kind. (lettering service, e-mail and others), b. To limit purchasable resource to one specific resource or not to do; giving choices to purchase some other resources, c. P time: time gap of coupon sending time and sale closing time, d. Contents to be contained on coupon, e. Setting target of coupon sending: own membership, requesting mobile advertising agency, or other cooperation company membership, f. Quantity of coupon sending on each above conditions, g. Allocation of quantity of coupon sending on each customer group (A percentage of every each customer when “unit quantity of coupon-sending” divided by customer group.)

After inputting above conditions, the conditions are reflected in schedule of every resource and the system sets sending plan automatically. The condition a, b, c, d, e, f are saved the DB 400 (sending plan database) and the DB1020 (message database), and the condition g is saved the DB 800 (Allocation of quantity of coupon on each customer group database)

Purchasable condition setting process on each member (S1130) is a step that a member inputs and revises preferring time frame and geographical condition for coupon using by himself.

Inputting preferring time frame of purchasable condition setting is very important especially movie, theater, and air ticket that are highly time-affected service. Purchasable time frame means sale closing time of the resource that a customer can use the received coupon and buy a resource. (in a case of service, purchasable time-frame means available time of the service and a customer can use the service from that time)

Coupon receiving location is saved the purchasable condition on each member database (650) with preferred coupon-receiving time-frame. It is progressed by choosing and inputting the location on purchasable time frame; home, office, or main sphere of action). The DB 650 contained purchasable condition on each member will be used in a process of target selection for coupon sending.

Generating process of “prediction of rate of sale database” is a step that estimates rate of sale of coming sale-closing time. It is saved the DB 500 (predicting rate of sale database) with rate of sale data of the past.

This present process is divided two process; one is collecting original data from the DB 500 (predicting rate of sale database) and saving the DB 470 (history of rate of sale database), the other process is that processing the original data and making the DB 500 (predicting rate of sale database).

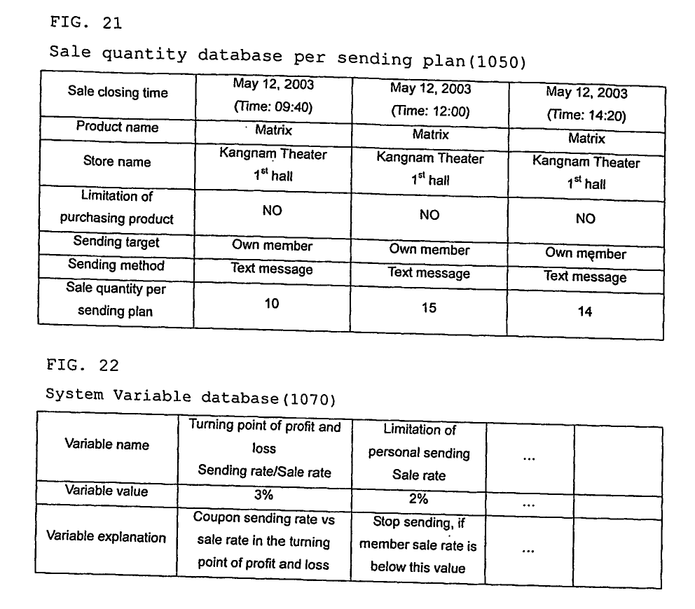

The original data for making the DB 500 (predicting rate of sale database) is saved data, changes in rate of sale about one resource on product schedule at regular time interval. The transition of all changes in rate of sale from opening to closing is saved. The interval of data saving is differentiated by kinds of resources. For example, in a movie, the interval of data saving is 10 min. from starting reservation to closing by searching rate of seat reservation on movie theatre. FIG. 21. is a chart to show transition of all changes in rate of sale(of movie ticket) as a original data of changes of rate of sale.

Among the original data, calculating the pairs of value of sale volume at sale-closing time and value of sale volume before P hours of sale-closing time on each resources and making normally distribution of the average value of sale volume before P time of sale-closing against value of sale volume at sale-closing time, and then the average value of sale rate before P time of sale-closing will be the value of sale closing time against the sale rate before P time of sale-closing. (Hereinafter referred to “P time”, the time gap of sale-closing time and coupon sending time)

Opening the sending process (S1210) is a step that starts a sending process when the sending time of the sending plan database and time on now is exactly same.

In a movie, if there are 23 sending plans which is supposed to send at this time when the one-way time expiring coupon system searches sending plan database (300) at 1:20 P.M., the system will start the sending process simultaneously for all 23 plans.

Decision process of quantity of coupon sending (S1220) is a step that decides some key items for profits and the earning rate. How many coupons should be sent on the thousands of same product schedule? How to use the residue of product to increase profits?

At this present invention, a purchasable resource cannot be contained on coupon and that makes increase the rate of sale vs. quantity of coupon sending.

It is reasonable to send coupon of product having highly sale rate. Because of this reason, there is a issue that how to decide the quantity of coupon sending without considering preference of product schedule which is affected sale rate. So this invention uses this way: quantity of coupon sending is determined by kinds of resources and the assignment of product schedule is not contained the coupon then the coupons are sent. The whole volume of coupon sending is decided combining with preference of every each product schedule.

The first step of decision process of quantity of coupon sending (S1220) is the limit process of quantity of coupon sending by the profit-and-loss account.

One-way sending time expiring coupon system controls quantity of sending coupon-using comparison of “percentage of quantity of sending vs. rate of sale”. If a result of that “rate of sale” of the latest product schedule after sale-closing time from the Product schedule database (300) divided by quantity of coupon sending from the Product schedule database (400) is under the percentage of quantity of coupon sending vs. rate of sale at even-points, the quantity of coupon sending that in now on the list to send will be decreased until the minimum which is set before or stop sending.

The ratio of quantity of coupon sending and rate of sale is a guidepost of an earning rate in this system. If the sale profit goes under the cost of coupon sending, this service will be loss. So the quantity of coupon sending should be set to minimum volume or stop sending, before finding the reason decrease of rate of sale or sensing the changes of situation. The calculation of rate of sale and quantity of coupon sending is like this;

Quantity of coupon sending*cost of unit sending (rate of sale*unit cost of sale*percentage of coupon profits among “unit cost of sale”+cost of sending and sale among all costs.)=0,

At this point, percentage of result of rate of sale divided by quantity of sending.

After limits process of quantity of coupon sending by the profit-and-loss account, deciding process of quantity of coupon sending is branched off to one from two type on inputting data by a administrator. The Two type is; One is that P time is small or same as sale cycle of a resource and the other is P time is much more bigger than sale cycle. A sale cycle means difference with sale-starting time and sale-closing time of a unit resource. In a movie, a sale cycle is from 1 hour to 3˜4 hours, but in a theatre it is 3˜4 hours or 1 day. Fruits are 1 day, clothing is about 3˜4 months (one season). It is oriented the kinds of resource.

Therefore, deciding process of quantity of coupon sending in a case of that P time is bigger than a sale cycle is recommended for these resources; movie or theatre having short sale cycle. When the system offers same service at same specific time-frame periodically, it calculate the quantity of coupon sending easily with predicting a rate of sale in the future from the rate of sale in the past on same resource. The estimated residue of sale will be same as in the past.

Deciding method of quantity of coupon sending in a case of that P time is small or same as than a sale cycle is like below.

When the sending process is started, the system searches rate of sale on now from the sale network server database (170) and estimate rate of sale at sale-closing time from the DB 500 (predicting process of rate of sale database). When the estimated rate of sale at sale-closing time is 100%, the system stop to send because there will not be any residue. But if is under 100%, the system sends coupon using the following calculating method of quantity of coupon sending.

Elements to decide quantity of coupon sending are like this: preference of resource, available time-frame(in a case of service offering), goal quantity of sale (of one-way sending time expiring coupon service company) and expected percentage of quantity of coupon sending and rate of sale.

Preference of resource and available time-frame is already reflected to rate of sale until now and it is replaced with rate of sale p hours before sale-closing time. The goal quantity of sale on each periods is reflected in multiple type of rate of sale P hours before sale-closing time.

When the result of that rate of sale P hours before sale-closing time multiply quantity of coupon sending is over or same as predicted residue at sale-closing time, the predicted residue will be the goal quantity of sale. And it is under predicted residue at sale-closing time, the result of that rate of sale P hours before sale closing time multiply quantity of coupon sending will be the goal quantity of sale. The quantity of coupon sending is calculated by that goal quantity of sale divide by percentage of quantity of coupon sending vs. rate of sale that is set in system.

If rate of sale P hours before sale-closing time*quantity of coupon sending multiple 2 predicted residue then the goal quantity of sale=predicted residue

Else the goal quantity of sale=rate of sale P hours before sale-closing time*quantity of coupon sending multiple

Quantity of coupon sending=the goal quantity of sale/rate of sale compare with quantity of coupon sending.

Ratio of rate of sale compared with quantity of coupon sending is a result of that number of sent-coupon divides by ratio of rate of sale compared with quantity of coupon sending. Because of this reason the explained percentage of quantity of coupon sending vs. rate of sale use only the data of the past. A percentage of quantity of coupon sending vs. rate of sale is differentiated by time frame, offline shop, characteristics of resource and combination of customer group. So that whether it use the average of the percentage or not to do is depended on analysis of ratio of quantity of coupon sending compared with rate of sale after service offering.

The predicting rate of sale database (500) is based on data of the past, saving rate of sale at sale-closing time on rate of sale P hours before sale closing time as a experience database, which is made for high accuracy from sale rate estimating database (500) making process based on the sale rate on closing time correspondent the average sale rate on sale closing time to sale rate before P time of selling by normal distribution of sale rate data before sale closing time against sale rate before P time of selling.

A decision on multiple of quantity of coupon sending is depended on the goal quantity of sale. A decision on multiple of quantity of coupon sending using analysis on market scale on each resource is over the extents of this present invention. But the goal quantity of sale of service industry is recommended to set under the limits not to encroach profits by normal selling way. Selling by this one-way sending time expiring coupon makes the whole quantity of sale increase, even though it encroaches profits by normal selling way a little bit, but when the sale by this system increase too highly, certain amounts of sale is replaced to coupon of this system (It offers discounted price). After all whole profits of sale will decrease. To have effective influence to in market this system has to control the whole volume of coupon sending.

Deciding process of quantity of coupon sending in a case of that P time is bigger than a sale cycle is like this;

In a case of that P time is bigger than a sale cycle, to predict rate of sale at sale-closing time, the system calculate the quantity of coupon sending using rate of sale data at offline shop of the same resource and same time-frame. For example, it shows B movie at 3 times at A theater on Monday and the occupation rate is 12%. This results rate of sale data at offline shop of the same resource and same time frame. According the results, the system estimates occupation rate of Tuesday would be 12%. Preceding coupon sending (coupon sending of the same resource and the same sale-closing time in the past) shows result of sale, the system use predicted rate of sale of the preceding coupon sending again, and progress the deciding process of quantity of coupon sending and finally determine the quantity of coupon-sending.

When the results of that rate of sale P hours before at preceding coupon sending multiply quantity of coupon sending multiple is same as or bigger than residue of sale (data in the past from receding coupon-sending), the residue of sale is the goal quantity of sale. But it is under the residue of sale, result of that rate of sale P hours before at preceding coupon sending multiply quantity of coupon sending multiple is the goal quantity of sale.

If rate of sale P hours before at preceding coupon sending*quantity of coupon sending multiple≧residue of sale at preceding coupon sending then the goal quantity of sale=residue of sale at preceding coupon-sending

Else the goal quantity of sale=rate of sale P hours before at preceding coupon sending*quantity of coupon sending multiple

Quantity of coupon sending=the goal quantity of sale/percentage of quantity of coupon sending vs. rate of sale.

In the case of that P time is small or same as than a sale cycle, the system uses the data in the past. It has a long purchasable time and much more high percentage of quantity of coupon sending vs. rate of sale. After all, it cannot use the same percentage of quantity of coupon sending vs. rate of sale of short P time. The system saves different percentage of quantity of coupon sending vs. rate of sale on different P time on the sending plan database (400) and sends coupon according to the result of coupon sending.

Making conditions of target selection for coupon sending and process of target selection for coupon sending (S1230) is a step that determines specific targets from some customer groups and quantity of coupon sending in detail. That step is executed after that decide whole volume of coupon of the specified resource of specific shop—in case of film, resource will be specified Nth movie of XX theatre in Nth date—which close sales on certain time on decision process of volume of coupon-sending.

Allocation of quantity of coupon on each customer groups is executed by administrator of “one-way sending time expiring coupon system”, who inputs allocation ratio data about specified resource which close sales in certain time, according to properties of the resource into DB(allocation of quantity of coupon on each customer group database) by oneself. (Refer to the input process of conditions for coupon sending)

This is process of target selection for coupon sending. (S1230)

First, search frequency of coupon sending on each member from DB frequency of coupon sending on each member database) which contains classified data on each kind of specified resource and select members who is under-limited frequency.

At this time, a limit of frequency on every resource can be change according to type, check the frequency of coupon sending on each member referring to limit of frequency on kinds of goods database.

After checking the frequency of coupon-sending, in the case of that resource is highly service time-affected just like movie, theatre, and airline ticket and the time-frame leads possibility of purchasing, input possible time-frame on each member and save into conditions of possibility of purchasing database (650) in advance. Then select targets who are possible to buy the goods that is now on the sale through coupon sending from condition of possibility of purchasing databases (650) when the time of member selection for coupon sending.

After time-based selection of above members, the selection is about affected resources and members of those who are very near from the shop and can buy within the time-frame, in references with geographical points of affected stores, a kinds of resources, target area of coupon sending based on shop area database that saves a range of geographical position of customers who can buy resources by P time (700) and home address, office address of members information database (600).

At this time, information where a member is with two conditions of possibility of purchasing database (650) and another DB that is inputted by each of member about zone classified house, office, main sphere of action as the time frame.

After all of the process above-mentioned, research database contained allocation-ratio of quantity of coupon and result of rate of sale on each customer groups and if there are results data about rate of sale on each customer groups of the same resources which is sent before and is about to forward, set the same allocation-ratio of quantity with the results of rate of sale. If there's no result, input the initial value by administrator. Select some members who are in the customer group that is set the allocation-ratio as the quantity from members information database (600)

Finally, it is decided to send or not the coupon, searching quantity of coupon sending vs. rate of sale on each member with quantity of coupon sending on each member and rate of sale database (660) and relation with percentage of purchasing on every each member and coupon sending with system variable database. Also it is considered propensity to consume of every each member using quantity of coupon and rate of safe saved data of the last a few month.

For that, save some data every single day when the system does not send coupon, extract quantity of coupon sending and rate of sale for the last one year from sale database (1000) and sending database (900), calculate the number of sale and save quantity of coupon sending and rate of sale into rate of sale database (660).

In the case of above, it has enough members to send-coupon. In the case of shortage of members, less quantity of coupon sending with the process which is addressed above, there's a way to request coupon sending to mobile-marketing agency. Even in the case of request coupon sending to agency, the quantity of coupon sending which was set at the prior process is have to be classified quantity of coupon on each group according to the Allocation-ratio of coupon sending on each customer group database (800) that is inputted on sending packet by administrator. Set the residence area of target of coupon sending referring to target area of coupon sending on each shop database (700), make condition-note of every each target member that is supposed to be sent server of mobile-marketing agency and then save the sending database (900).

A process about naming own code number and contents insertion (S1240) is a step to accomplish coupon to forward. It is named as own code number with the list of target member made just a prior process on every. Code number is saved with selected message code in coupon sending plan database (400) into sending database (900).

In the case of request coupon sending to mobile-marketing agency, generate different code into conditions of target selection for coupon sending on each member that is made prior process and save with selected message into sending database (900).

The core of this present invention is operating technology that makes possible one-way sending time expiring coupon. Every coupon has own code number and is sent to customer and the own code number is saved sending database (900). When a customer has received coupon access the system for purchase, the system check the customer's code number and code number in sending database. (900) and inform identicalness of the two code numbers and gap of customer's access time and purchasable time frame.

In the process about request of coupon sending to mobile Advertising agency (S1250), the coupon that contains conditions of target selection for coupon sending on each members and contents is delivered a server of mobile-advertising agency, reading from sending database (900).

Sending-itself Process (S1260) is a step that send coupon that is saved in sending database (900) using message-sending program and E-mail server.

Message-sending program and E-mail server is widely and commonly used because those can be set up into the system computer and others also.

Access process on sale system (S1310) is used only online purchasing. When a customer who get coupon with cellular phone access, Call back URL contains own code number request Web Server, and the web server send the code number to Web application server. Then web application server checks the identicalness of code number of coupon and system, sale close time of the resource on sending database to Web server (400), and purchasable time and place.

In a case of member, the system informs the purchasable time and progress the sale process. In the other case, the system informs the purchasable time frame and persuades to join the membership and if the time is available, the system progress the joining membership and give a rights to purchase.

If a customer who receives a coupon from e-mail clicks the access link in received e-mail, the own code number that is contained address of link is compared with the code number in sending database to Web server (400), check up the contents, informs the availability of buying, and progress the sale process.

When a customer wants to purchase with online to input the own code number received with cellular phone into web page, first of all, access the coupon site, log in and input the code number. The system checks sending database (400) of the code number and shows the availability on the web page and progress and the sale process.

Sale process (S1330) is divided two cases one is online sale and the other is offline sale.

In the case of online sale, the process starts with choosing the purchase web page with input devices as cellular phone, computer screen, button or keyboard by customer. When the rate of sales through coupon added into product schedule database (300) is under the quantity of predicted residue presumed at the time of coupon sending saving in sending plan database (400), the sale network check the present quantity of residue, and if there are any that can be available show the list of available resources in order to the nearest shop on a screen. At this time, the sale network shows specified resource on the list, if the coupon is only for sale of specified resource. This is logic of decision for customer's location check up. Research the purchase capability condition database (650) using customer's ID, check the zone that is inputted by the customer where he is according to time, find out the address of the zone from the members information database (600) and shows the nearest shop where he is now. In a case of the Republic of Korea, a decision of nearest shop use zip code and show the same zip code of shop and customer's predicted present place. A customer can see the few of zip code that is same except last 1 and 2 number in numerical order. That means the last number is about village, and the 2nd last number is district and a customer can find some shops within his village or district. Showing the nearest shop in much more important issue, when a customer wants to do cellular phone access than web page access. If the system shows unavailable shop to customer within the time frame, customers who use cellular phone could complain and it could lead decline of rate of sales because the screen of cellular phone is small, a customer can see only a few items and the loading time is slow. A customer chooses item and piece among list on screen, the system progress next step, and payment process.

An approval of payment process is divided two case, online and offline.

In the case of online purchase and online payment, there are many ways, credit card, adding telephone charges, E-money, and points of cards, to pay for the resource. The information of payment is transmitted directly to mobile communication company or credits card company that settles the payment. The result of sale is delivered to sales network, then when a customer who use online purchase go to the shop can get the resource with ID check. When the acknowledge of brand on coupon becomes weak, it is recommended to pay at offline shop even a customer use online purchase that makes customer feel reliance and rate of sale could increase.

In the case of offline payment, the own code number, piece and information of resource and customer's information are transmitted to the sale network at the online purchasing. When a customer comes to shop and ask a resource, an employee inputs customers' ID number into terminal computer on shop and check the customer's results of purchase with sale network server. After checking the customer's purchase with online, an employee on the shop progress the payment process and then give the resource that is accomplished all the process of purchase and payment.

In a case of offline purchasing, a customer who got a coupon with cellular phone shows the own code number on screen of the cellular phone to employee on the shop. A customer who got a coupon with e-mail shows printed coupon and an employee accesses sale network and Sale Network Server check the identicalness of two own number codes, one is just inputted by a employee and the other one is saved from One-way sending time expiring coupon server (100, 200) and shows availability of a resource with discounted price. Result of sale is transmitted to one-way sending time expiring coupon server (100, 200) and used feedback data.

At this time, only in the case quantity of rate of sale added in schedule of resource database (300) is under predicted residue presumed at the time of sale closing, sale of a resource is possible to search now on residue in Sale network. In this process, there are many ways that the own code number is transmitted to the terminal computer in shop; barcode, payment system with infrared ray, RF communication system and as the above just showing screen of cellular phone.

In this process, there are many ways that the own code number is transmitted to the terminal computer in shop; barcode, payment system with infrared ray, RF communication system and as the above just showing screen of cellular phone.

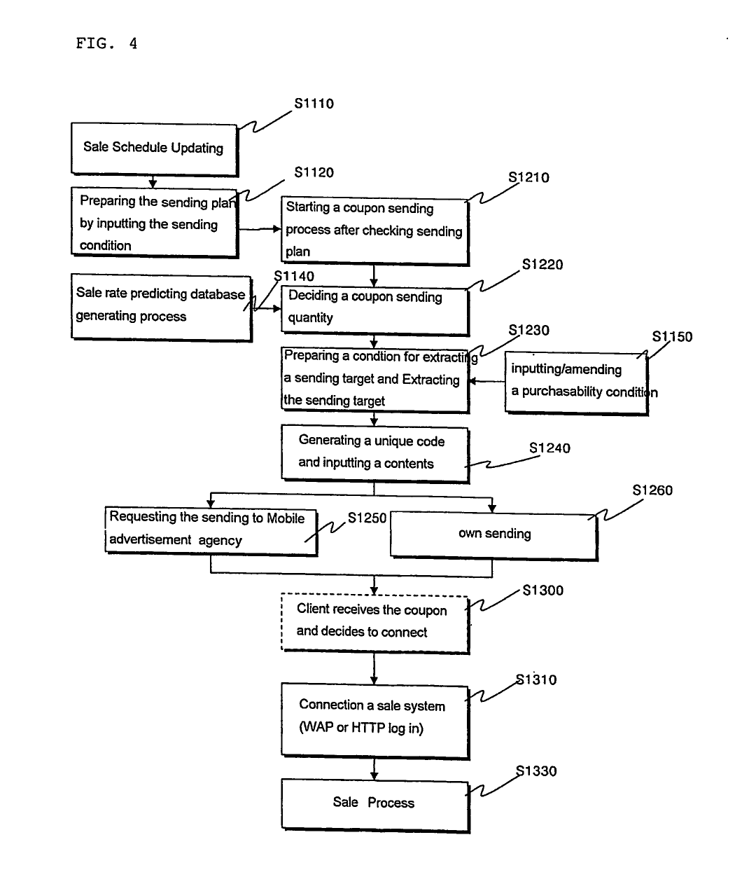

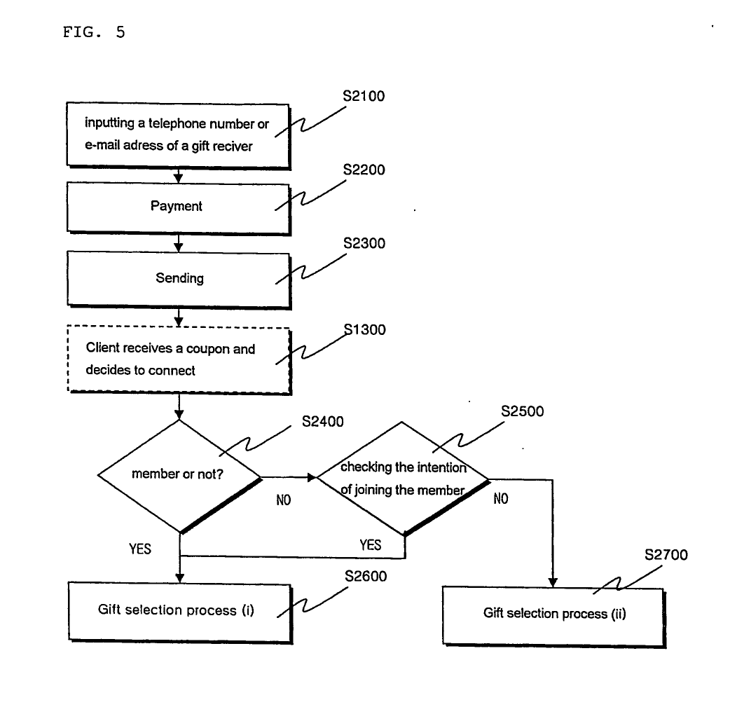

FIG. 5 is a flowchart of operation example about process that one purchase a product and the give another person with online.

In this operation example above, the process that one purchase a product and the give another person with online contains several process; Input process of receiver's phone number or e-mail address(S2100), payment process(S2200), sending process(S2300), receiver's ticket receiving and determining access process(S2350), membership check process(S2400), asking to join membership process(S2500), Sale process(i) (S2600), and sale process(ii (S2700).

To be brief, this process is same as gift certificate ticket one purchase and pay to a product and the other receiver get the product.

This system is very effect to one-way sending time expiring coupon business as a way increase the rate of sale vs. quantity of coupon sending because even though coupon receiver can not purchase a resource, he pay it and cab present the resource.

Sale system has also a menu to present to others. One pay for a item and input receiver's phone number or e-mail address, the one-way sending time expiring system send the already discharged-coupon to receiver's phone or e-mail. A discharged-coupon receiver just accesses the system and checks the own code number of the item. Then he goes to a shop and has a resource in his hand.

Referring to FIG. 5. when a member who got a coupon decide to present to friend, he just choose a menu to present, input a phone number and e-mail address and discharge for that with online. One-way sending time expiring coupon system save result of sale as present mode of selling-channel into the DB 1000 (Sale database) and send a coupon to the inputted number or e-mail address. At that time the system generate hew access code number, set up classifying code for sending as “present mode”, correct sale closing time from now to P. hours later and save sending database (900), finally send the coupon to receiver.

This presented coupon has difference on accomplishment of payment with one-way sending time expiring coupon explained FIG. 4. because it is already discharged.

The one-way sending time expiring coupon system checks the own code number when a receiver get a coupon and access the system with cellular phone or computer. The system confirms whether the person who access the system is a receiver or not and notify coupon receiving and show a choosing screen of resources. The one-way sending time expiring coupon system check whether a receiver is member or not with membership list using phone number or e-mail address

(i) if present receiver is member or join membership, when he complete choosing item, the system generate new own code number, save sale database (1000) with the information of chosen item and sends name of item, schedule, ID number and name to sale network. When A receiver shows ID card at a shop, a employee search customer's information with the terminal computer in shop and offer the item.

(ii) If a present receiver is not member and deny to join membership, the system generate new own code number, save sale database (1000) with the information of chosen item and sends name of item, schedule, to sale network. The newly generated code number uses as ticket number. When a receiver shows ticket number at a shop, a employee search ticket number with the terminal computer in shop and offer the item.

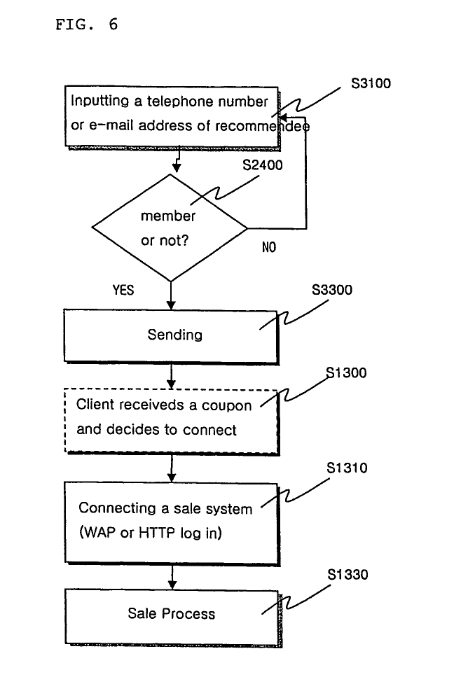

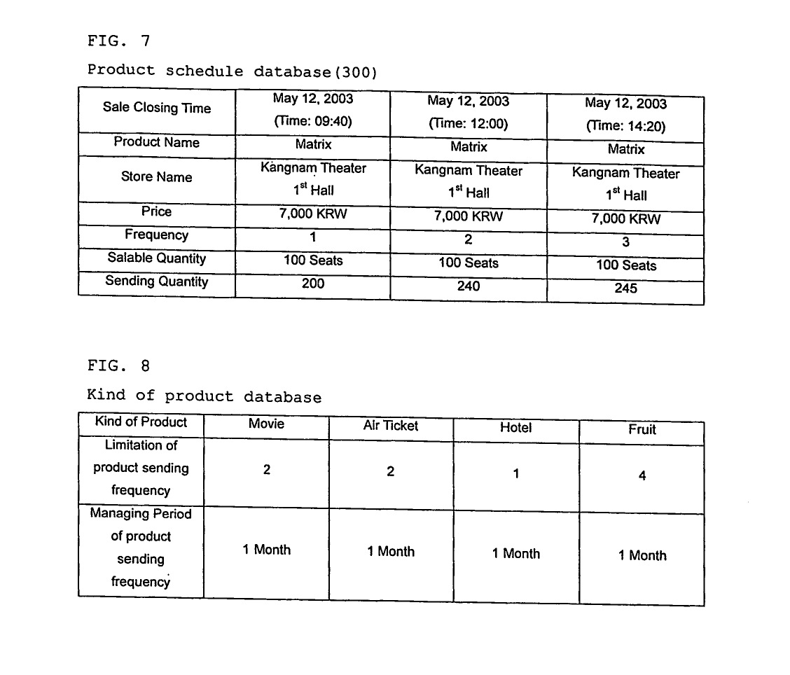

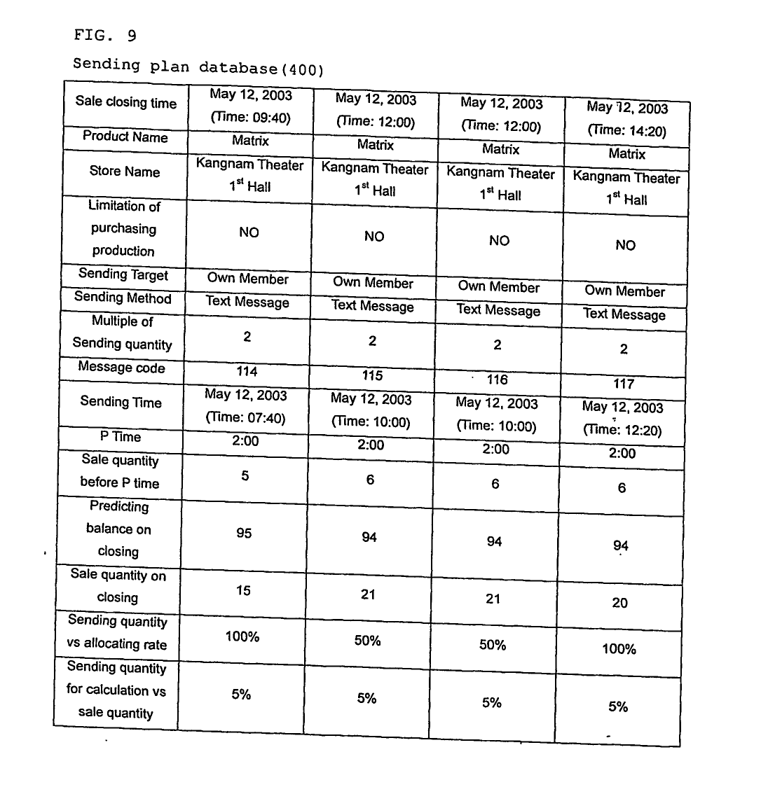

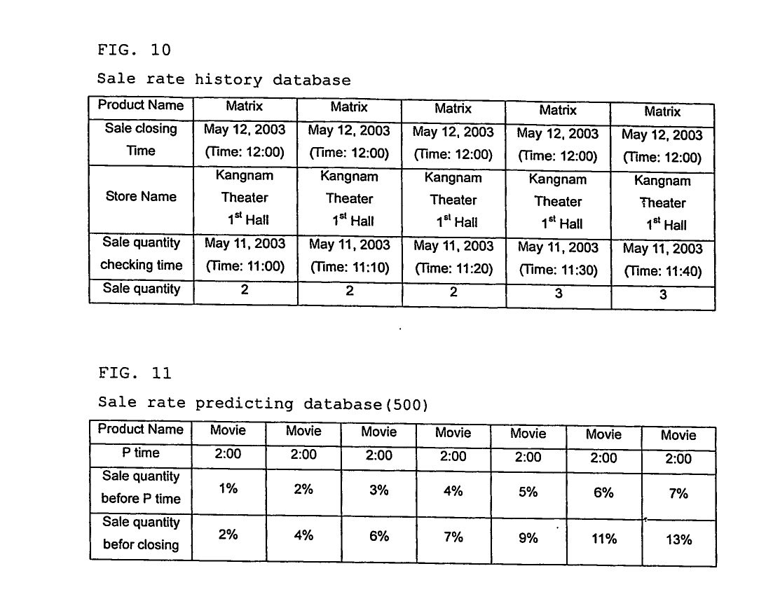

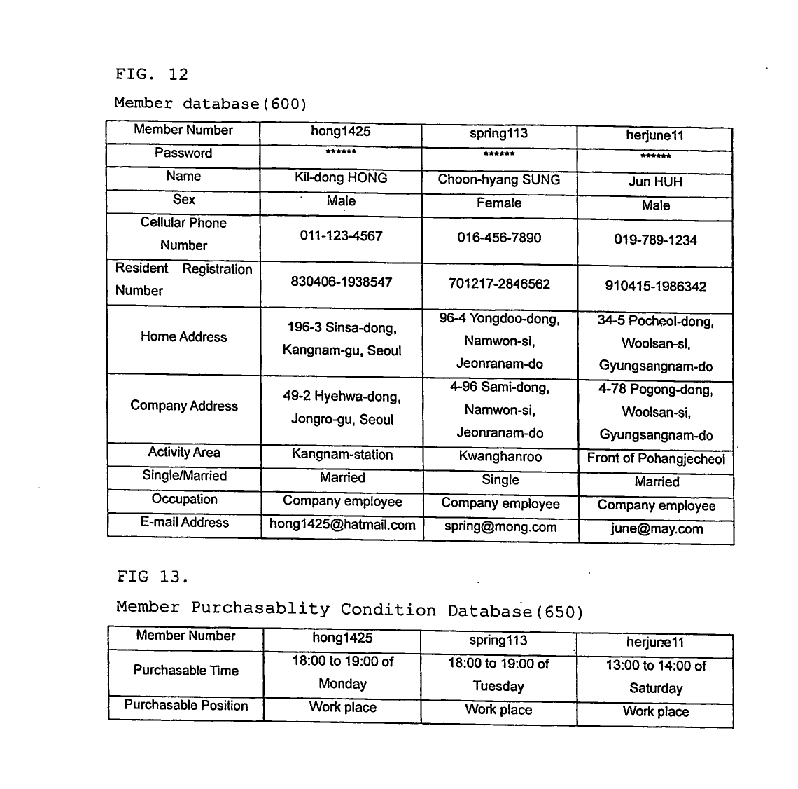

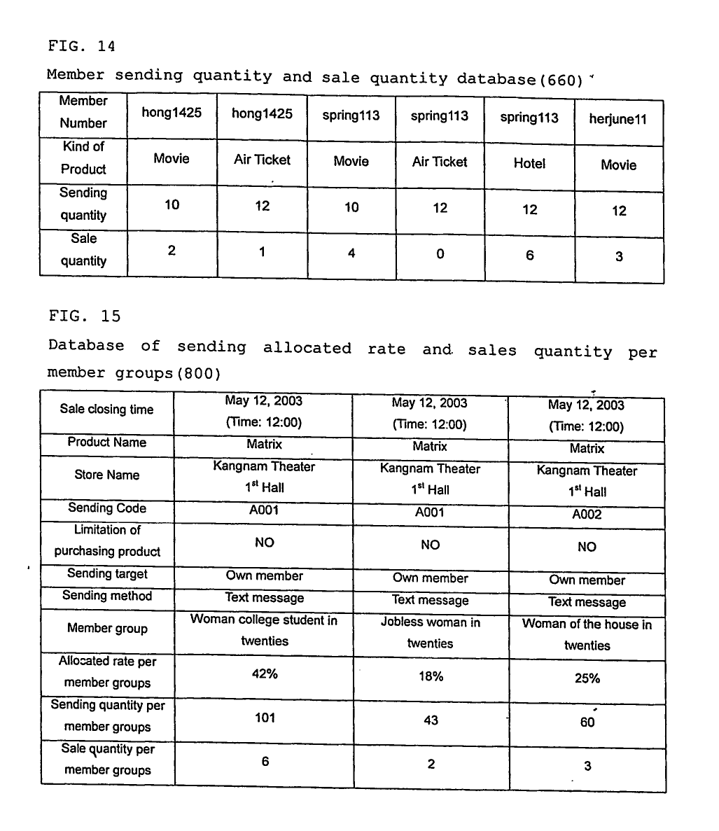

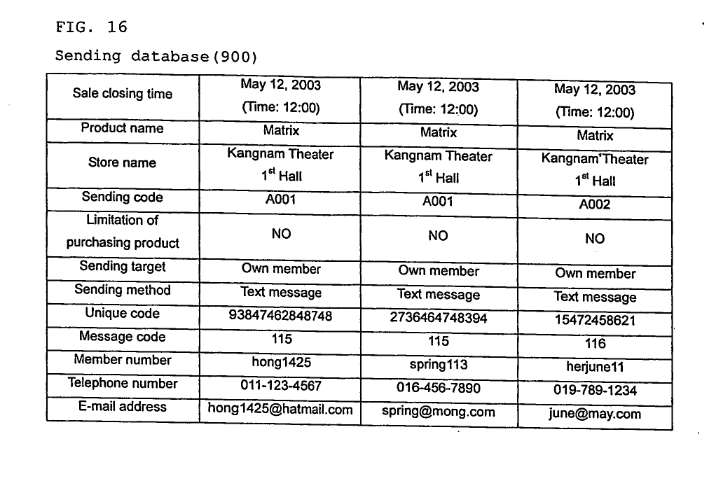

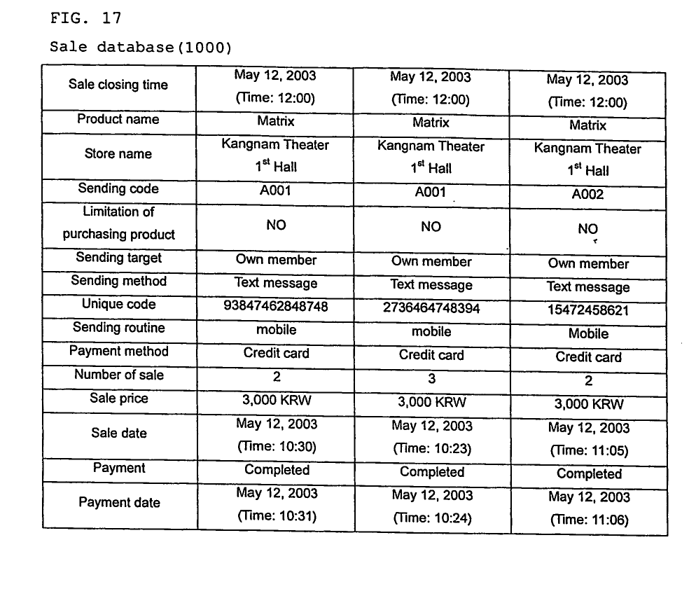

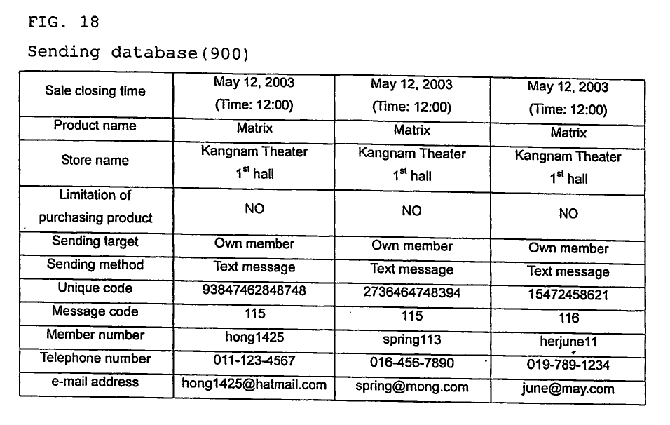

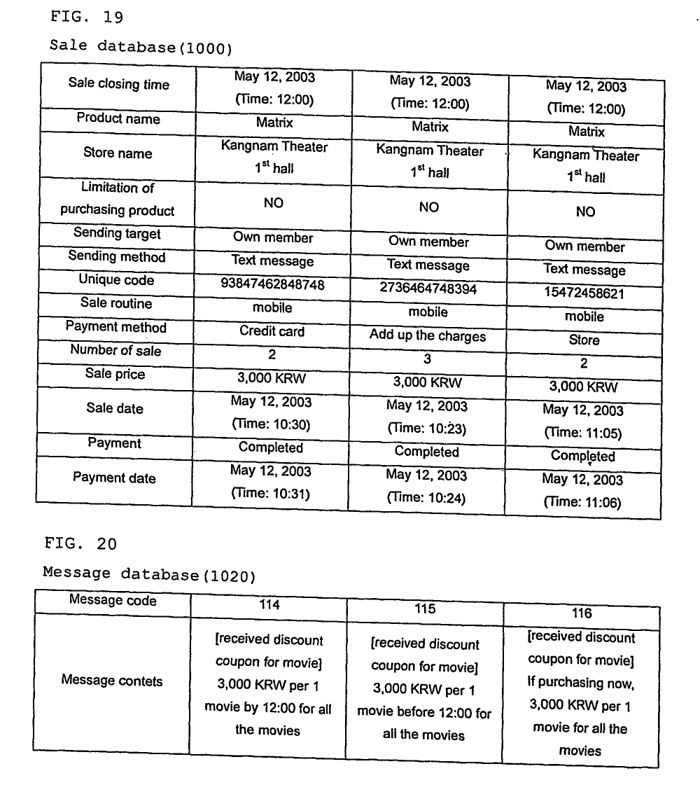

FIG. 6 is a flowchart of suggesting process to join membership to friends.

In this operation example, the process of suggesting process to join membership to friends contains several process; input process of recommendee's phone number or e-mail address (S3100), membership check process(S2400), sending process(S3300), receiver's ticket receiving and determining access process(S1300), access process to sale system(S1310), and sale process(S1330).

When a member feels usefulness of one-way sending time expiring coupon service and wants to suggest joining membership, a member access the system, choose a suggestion menu and inputs recommendee's phone number and e-mail address. Then the system sends one-way sending time expiring coupon and suggest purchasing to recommendee with the number of e-mail address.

This method has good effect on membership register that is very important to one-way sending time expiring coupon service.

Explain the process to suggest joining membership in detail.

Firstly, a screen will be shown that is for inputting recommendee's phone number and e-mail address when a member access the system and choose membership suggestion menu. After that a member inputs phone number and e-mail address, the system finds out a whether a recommenddee is member or not with the DB (membership information database), and sends coupon(S2400), but in a case of that a recommendee is member the system reply he's a member, In a case of the a recommendee is not member, the system save the inputted phone number, e-mail address, newly generated own code number, sale closing time which is setting from now to N hours later, and classifying code for sending and sends coupon.

Afterward process of it is same FIG. 4; the process that a coupon receiving customers access the sale system.

This is explanation of one of applications on this present invention service for understanding.

It explains about application of this present invention using movie ticket.

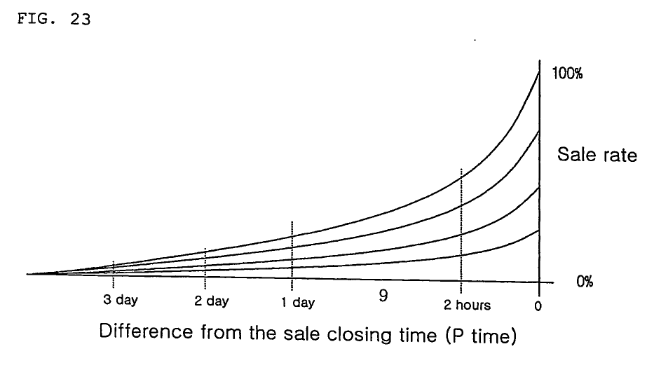

FIG. 7 or FIG. 22 shows data structure of one-way sending time expiring server as a application-of example.

A film running on a theater has exact product schedule (time schedule on a theater) and quantity of product (number of seats) so that if it does not taken at fixed time (running time and time schedule) the untaken seats are became totally loss. For these reasons, a film on a theater shows property of the target market of this service.

Referring to FIG. 7 or FIG. 22, an administrator inputs quantity of allocation on each groups according to contents of movie since a movie starts on a theater. A administrator sets coupon type as lettering service of mobile phone, sending time as 2 hours before sale-closing time, inputs contents of lettering service to be sent and sets every setting for coupon sending. Finally, a administrator push a button for coupon sending and sending plan is made according to schedule of every theater showing the same movie as conditions that is inputted. Then all these setting save sending plan database (400).

The one-way sending time expiring coupon system search time schedule of movies of every joining theater from reservation of network about movie ticket, updates product schedule database (300), and let a administrator to change changed time schedule of a theater and sends coupons.

The one-way sending time expiring coupon system starts the process (S1210) of coupon sending as sending plan watching sending plan database (400).

Referring to FIG. 7, it is at noon and a coupon sending time as plan of Kangnam theater; there's a movie “Matrix” at 2 P.M. 1st house of Kangnam theater.

The one-way sending time expiring coupon system search rate of sale and quantity of sending of prior product, a movie “Matrix” at noon 10 minutes before closing time. Using the DB 1050 (rate of sale on sending plan database) and product schedule database (400) the system finds out quantity of sending is 200, and used coupon is 10. It is 5% rate of sale vs. quantity of sale and the system progress the next process because it is over the even point, 3% rate of sale vs. quantity of sale which is saved the DB 1070 (system variables database) The system shows the quantity of reservation of the movie “Matrix at 2 P.M. is 6 and it is 6% rate of reservation because the whole number of 1st house of Kangnam theatre is 100, this information is saved in the DB 300 (product schedule database). If a rate of reservation is 6% at 2 hours before showing of movie, the rate of sale would be 11% using the DB 500 (rate of sale forecasting database), so the untaken seats would be 89. 12 tickets are esteemed that 2 of double sending volume multiples 6 of present advance purchase volume set in sending plan database (400), and the aim volume is to be 12 because they are not more than the expected 89 rest seats, and the sending volume is to be 240 tickets because the selling volume against ratio of last sending volume is 5%.

The quantity of sending is set, the system select target members as quantity of sending from the database of members. The target is selected to check with every conditions of target selection for coupon sending. The system searches the DB 670 (frequency of coupon sending database) and selects some members who has received a coupon 1 or 2 times in this month.

The system calculates percentage of “rate of sale vs. quantity of sending” on each member as rate of sale and quantity of sending with rate of sale and quantity of sending database (660). The system check whether this outcome is over the lowest percentage of “quantity of sending vs. rate of sale” which is saved system variables database (1070) or not, and if there are somebody who is applied this result, they would be selected from above members.

From them, the system select some again who has inputted purchasability of film ticket from 2 to 4 P.M. available time of target product of this example, into the purchasable condition on each member database (650).

Then the system two DB and select some of them. One is the purchasable condition on each member database (650) that has available area of the members and the other one is DB 700. This is for finding only some members who is in the area.

The rate of sale on each customer group on the movie “Matrix” which is on Kangnam theatre lately with rate of allocation and sale on each customer group database (900) is college woman 42%, 20's unemployed woman 18%, 20's housewife 25%, and 30's housewife 15%. This results is applied as the whole quantity of coupon sending 240 sheets, then the system selects college woman 101, 20's unemployed woman 43, 20's housewife 60 and 30's housewife 36.

At this time, to send coupon of 30's housewife 30 is requested to mobile marketing agency. Transmitting data to request is conditions of target selection (30's housewife in the target area of A theatre), contents of lettering service, and call back URL contained the own code number. After saving those data and the own code number and message (of lettering service) code, it is transmitted as the agreement with mobile marketing agency.

A mobile marketing agency selects target according to conditions of target selection for coupon sending from the membership information data of mobile communication company and sends coupons.

Also a mobile marketing agency gives own code number to members who is selected from their own membership list and save the sending database (900) with ID and phone number and then sends coupon with their own lettering message sending server.

The one-way sending time expiring coupon is delivered by lettering service type of mobile phone. There's a message, “discounted movie ticket to 3000 won, available until 1:40 P.M.” on a screen of cellular phone. When a member push a access button it is logged-in automatically, and in a case of that a coupon-receiver is not a member of the service there is a suggestion message to join the membership. Checking whether a receiver is a member or not is through the own code number on the DB 900 (sending database) and call back URL.

After logged-in, a receiver can select movie list or theatre list. When he choose a movie list there's a list of movie that is available on a screen and when he choose a theater list, there's a list of theaters that is ordering to distance where he is.

A screen shows some selected movies among the target movies at 2 P.M. The selection condition is having untaken seats that rate of sale on coupon is under the predicted quantity of residue.

The payment process progresses after that a receiver chooses a movie and number of seats. The payment has two type, one is online payment (charge on ticket price to cellular phone bill or credit card) the other one is offline payment (pay for the ticket price at the movie theater taking ticket. After choosing all of the choice, the result of sale is transmitted to sale network. When a receiver goes to a movie theater a employee of the theater check the payment situation and give a movie ticket to the receiver. Finally the coupon receiver can see the movie as a discounted price and easily.

A difference of one-way sending time expiring coupon with normal coupon is offering only some selected people who are supposed to get not everyone. If those selected people can predict coupon-receiving time, they must take discounted-product always. That can makes product-offer damage on their business. For those reasons, the coupon should be delivered unpredictable and irregularly on schedule and quantity.

The irregularly quantity of coupon is executed by the way to set the average quantity of period that is multiple of some fixed period instead of setting quantity of sending on everyone for fixed period (for example one year). For example, the average times of sending is fixed for 10 years, but the times of sending on every each year is different. In this example, coupon-receivers cannot predict how many times he get coupon in this year.

This is an example.

| | | | | | | | | | Average |
|---|---|---|---|---|---|---|---|---|---|
| 1st | 2nd | 3rd | 4th | 6th | 7th | 8th | 9th | 10th | of 10 |
| year | year | year | year | year | year | year | year | year | years |
| 6 | 9 | 13 | 15 | 8 | 7 | 14 | 12 | 5 | 10 |
| times | times | times | times | times | times | times | times | times | times |

The interval of coupon sending is set the minimum interval. The system selects coupon target using random function in the limit that is possible to send coupon when the interval is over the minimum interval. This method makes irregularly interval of coupon sending and a receiver of coupon can never predict the coupon-receiving time;

It is essential to issue own code number to membership and non-membership for operating system that has the structure of issuing own code number.

But, it is need to have alternative plan, in the case of requesting coupon sending to agency. Some agency does not input the own code number or cannot afford it. Therefore, you can use a way to use temporary public own code number.

Even though the temporary public own code number can be issued, some purchase conditions and time limits should be saved the sending database (900). The temporary public own code number means issuing same code number to non-membership to be sent at one time. The temporary public own code number is issued only joining membership for non-membership. The existing membership cannot use this temporary public own code number even if he could access the system. It makes the system keep from drain of the temporary public own code number.

The method of using the temporary public own code number just explained makes possible one-way sending time expiring coupon system to ask to agency without any difficulty.

The method in above explained a way to contain the own code number on one-way sending time expiring coupon, but there's no need to contain the own code number to existing membership. When the system sends coupon, is saves member's ID and the own code number as one set into the DB 900. So it is possible only to check the sending database (900) to finds out the own code number when a member logged in.

There is another way to use coupon effectively. The system input purchase conditions (for example, product name, pieces, and time) into coupon directly and sends them using password sealing. Then when a receiver use that password-sealed coupon, an employee confirms availability and forgeability of the coupon and checks the purchase conditions using password-sealing method.

PKI is recommended to use the methods even though the method has lots of variability. PKI is abbreviation of Public Key Infrastructure and publicly well known as password and sign certification method using symmetry key algorism.

In this present invention describes only the application method.

Using PKI, the electric signing is possible so it is very useful. If you do electric signing on purchase conditions which is main contents, kind of product, the available time-frame, when a receiver wants to use the coupon it is checked whether it signed by one-way sending time expiring coupon server or not and found out whether it is forged or not. The method to use PIK is only applied to membership coupon that is set target because there's no way to block file copy. If there will be perfect copy blocking technology, a coupon that does not contain members' personal information can be delivered with online

A preferred applied example is simple, but a professional who works in this technology area can understand how to use this present invention variably within extents of claim.

[Effectiveness of this Invention]

As explained, this invention can help to be sold specific resources that can be residue or extinguish and offer these resources as discounted price to customers. That means producers and also customers who use this invention make a profit.

Especially, this service makes possible some specific resources do remnantal sale and increase profitability of the resources business.

This invention is very good effects on increasing effectiveness of production and consumption. It pursues consumption of produced resources and helps not to be waste. This inventions is very environmental-oriented and economical system so that it protects economical loss, environmental damage and the squandering of the nation's resources.

1. A method for selling perishable resources using one-way sending time expiring coupons, comprising the steps of:
a) updating a sale schedule by inquiring information of resources to sell from a sale network server according to update cycles, and storing the information of resources in a sale schedule database;
b) constructing a sending plan database by preparing and storing a sending condition, sending information and a sending plan for coupon sending;
c) collecting past sale rate information, storing the collected past sale rate information in a sale rate history database, and constructing a sale rate predicting database by processing the stored past sale rate information to generate and store sale rate predicting information;
d) limiting a sending quantity of coupons based on profit-and-loss account and determining the sending quantity of coupons through a comparison of differences between the sale cycle, sending time and sale closing time;
e) constructing a sending target extracting database by extracting and storing member data corresponding to the sending conditions;
f) constructing a sending database by storing unique codes together with message codes stored in the sending plan database, and preparing a coupon based on the sending database;
g) sending the prepared coupon to the extracted member;
h) accessing a sales network system for member authentication by the member receiving the coupon; and
i) selecting resources, sending purchase intention and paying for the selected resources by the member authenticated by the sales network system.

2. The method as set forth in claim 1, further comprising the step of generating the unique codes corresponding to the extracted member data when the coupon is prepared in the step f).

3. The method as set forth in claim 1, wherein a sale, condition on which resources are available is stored in the coupon prepared in the step f), and the prepared coupon is signed according to a predetermined encryption method.

4. The method as set forth in claim 2, wherein the sending condition has different cycles at which information of resources is updated in a database and different database contents depending on kinds of resources.

5. The method as set forth in claim 2, further comprising the step of constructing a member purchasability condition setup database by storing available time zone information of the one-way sending time expiring coupon designated by the member and position information of the member.

6. The method as set forth in claim 2, wherein the step of limiting the sending quantity based on profit-and-loss account includes setting the sending quantity of current coupons for resource schedule to a predetermined minimum value or stopping the sending of coupons if a division of” quantity of sale for the latest resource schedule after the sale closing time passes among resources to sell at a store selling resources indicated in the current coupon “by” the sending quantity” is lowered below a ratio of the sending quantity to the sale quantity at a break-even point.

7. The method as set forth in claim 2, wherein, if at difference between the sending time and the sale closing time is similar to or less than a sale cycle, an expected residual quantity at the sale closing time is a sale goal quantity if a multiplication of” a sale quantity at P time before the sale closing time “by” a multiple of sending quantity” is equal to or more than the expected residual quantity, and the multiplication of “a sale quantity at P time before the sale closing time” by” a multiple of sending quantity” is the sale goal quantity if the multiplication of “a sale quantity at P time before the sale closing time “by” a multiple of sending quantity” is less than the expected residual quantity.

8. The method as set forth in claim 2, wherein, if a difference between the sending time and the sale closing time is more than a sale cycle, a residual sale quantity at a previous sending time is a sale goal quantity if a multiplication of “a sale quantity at P time before the sale closing time at the previous sending time “by” a multiple of sending quantity” is equal to or more than the residual sale quantity, and the multiplication of” a sale quantity at P time before the sale closing time at the previous sending time “by” a multiple of sending quantity” is the sale goal quantity if the multiplication of” a sale quantity at P time before the sale closing time at the previous sending time “by” a multiple of sending quantity” is less than the residual sale quantity.

9. The method as set forth in claim 7, wherein the sending quantity is calculated by dividing the sale goal quantity by a ratio of the sending quantity to the sale quantity.

10. The method as set forth in claim 2, wherein the step of extracting the member data includes:
extracting a member by inquiring a member coupon sending frequency for a predetermined period of time, which is stored in a sending frequency database for each kind of resource;
searching a member purchasability conditions setup database to extract only a member who can purchase a resource indicated on a coupon to be sent currently;
searching a sending target store area database and a member information database to extract a member who is assumed to be located in a position at which the resources of the store can be purchased for each kind of the resource and for each P time;
extracting a member belonging to a group of clients to whom a sending quantity is allocated, from the member information database by the sending quantity; and
extracting a sale quantity and a sending quantity for each member during the last one year at an idle time zone of one day during which a coupon sending operation is not conducted, from a sale database and a sending database, adding the number of times of sale and the number of times of sending for each member, respectively, and storing a result of the addition in a member sending quantity and sale quantity database.

11. The method as set forth in claim 2, wherein the coupon sending is performed according to a personalized message sending method.

12. The method as set forth in claim 11, wherein the personalized message sending method is sent through one selected from sending by a mobile advertisement agency server, sending by its own message sending server, and sending by an electronic mail.

13. The method as set forth in claim 2, wherein payment is performed through one selected from payment systems including an addition to mobile telephone charges, a credit card, electronic money, points of cards, and cash at a store.

14. The method as set forth in claim 2, wherein a coupon receiver's identity is automatically confirmed and the coupon receiver logs in the sale network system when the coupon receiver inputs his won unique code into an URL of the sale network system to access the sale network system by using the coupon.

15. The method as set forth in claim 2, further comprising a step of automatically determining which resources are purchasable by storing unique codes generated for each coupon together with sending information such as the sale closing time and target resources and comparing two unique codes with each other when the coupon receiver accesses the sale network system.

16. The method as set forth in claim 2, further comprising the step of chasing information of a coupon receiver using the unique code inserted in the coupon to grasp the quantity of purchase for each individual and the sale rate for each group of clients.

17. The method as set forth in claim 2, further comprising the step of displaying resources to sell in a store close to a domicile of a coupon receiver before a resource list is displayed.

18. The method as set forth in claim 2, further comprising a step of selling only for a residual quantity of a resource that is assumed not to sell, keeping some quantity of the resource to sell at a normal price.

19. The method as set forth in claim 2, further comprising the step of paying for a coupon received by a coupon receiver and then sending the paid coupon to another person.

20. The method as set forth in claim 19, further comprising the step of checking whether said another person receiving the coupon is a member or not, and inviting said another person to become a member if said another person is not a member.

21. The method as set forth in claim 2, further comprising the step of storing information of another person in a membership database by a member accessing a one-way sending time expiring coupon server.

22. The method as set forth in claim 2, wherein a sending interval and the sending quantity of the coupon are random such that clients can not predict the time of coupon sending.

23. The method as set forth in claim 2, wherein the unique codes are the same code to all members, and members having the unique codes are endowed with new respective unique codes when the members access a one-way sending time expiring coupon server.

24. The method as set forth in claim 2, wherein coupon numbers are allocated to databases for each member ID, and members access a one-way sending time expiring coupon server so that the members confirm sending of coupons and use the coupons.
